(19) United States
(12) Patent Application Publication
(10) Pub. No.: US 2023/0182105 A1
(43) Pub. Date: Jun. 15, 2023

(54) Systems And Methods For Carbon Dioxide Conversion

(71) Applicant: CARBOGENESIS LLC, Miami, FL (US)

(72) Inventor: David S. Soane, Coral Gables, FL (US)

(21) Appl. No.: 18/080,114

(22) Filed: Dec. 13, 2022

Related U.S. Application Data
(60) Provisional application No. 63/288,891, filed on Dec. 13, 2021.

(51) Int. Cl. B01J 19/08; C10G 2/00

(52) U.S. Cl. CPC B01J 19/088; C10G 2/50; B01J 2219/0869; B01J 2219/0873

(57) ABSTRACT

The invention includes a system for producing a carbon dioxide conversion product, where the system includes a carbon dioxide gas source providing carbon dioxide; a delivery system for the carbon dioxide in fluid communication with the carbon dioxide gas source, wherein the delivery system delivers the carbon dioxide gas into a plasma reactor, and wherein the plasma reactor energizes the carbon dioxide gas as a plasma to produce activated carbon dioxide species; a secondary reactant source providing a secondary reactant in a secondary reactant stream that is separated from the carbon dioxide gas, wherein the secondary reactant stream is directed to contact the activated carbon dioxide species in a reaction zone, and wherein the contact between the activated carbon dioxide species and the secondary reactant in the reaction zone produces a reaction that yields the carbon dioxide conversion product. The invention also includes methods of the use of such a system for producing a carbon dioxide conversion product.

### RELATED APPLICATION

This application claims the benefit of U.S. Provisional Application No. 63/288,891, filed Dec. 13, 2021. The entire teachings of the above application are incorporated herein by reference.

### FIELD OF THE APPLICATION

This application relates to systems and methods using plasma technology for converting carbon dioxide into higher-value chemical products.

### BACKGROUND

As human activities continue to release carbon dioxide into the atmosphere, there is an increasing awareness of its destructive effects on the Earth’s ecosystem, including accelerated polar ice melting and accompanying sea level rise, changes in vegetation and hydrological patterns, and more frequent disastrous weather events, all consistent with patterns of global warming. Global emission of greenhouse gases into the atmosphere has been estimated to exceed 35,000 teragrams (Tg) per year, predominately in the form of carbon dioxide, averaging about 5 tons per person. Reducing carbon dioxide emissions has thus been recognized as vital to mitigating and potentially reversing this damage to the environment. Some approaches, such as substituting renewable energy sources for fossil fuel combustion, can lower the emission of CO₂. Other approaches involve capturing the CO₂ that is produced before it enters the atmosphere or even after it has entered the atmosphere.

A significant amount of anthropogenic CO₂ can be captured and sequestered, or reused or both, thus decreasing the impact of this greenhouse gas on the environment. These processes, termed carbon capture and storage (CCS) or carbon capture, use and storage (CCUS), exist today and may expand in the future. Their effects can be significant. It is estimated that CCS technology can capture up to 90% of the CO₂ released by burning fossil fuels for electricity generation and for industrial processes such as cement production.

A CCS system includes technologies to capture CO₂, to transport it to a storage facility, and to provide short-term or long-term storage. A CCUS system includes technologies for using the CO₂ as well, so that the CO₂ is captured, transported, stored temporarily, and then used. Both systems involve similar carbon capture technologies for trapping the CO₂, but they differ in how they manage it afterwards.

CO₂ capture technologies for CO₂ emissions consist of chemical or physical mechanisms to absorb the CO₂ produced by combustion (post-combustion capture), or to separate CO₂ from fuel stocks before combustion (pre-combustion capture), or to purify combustion processes by providing oxygen instead of air as the reactant source (oxyfuel combustion). Of these options, post-combustion capture is the most efficient and most widely used. A range of technologies, including membranes, solvents, and catalysts, can perform this capture step. Once captured, the CO₂ is isolated, dried, and pressurized to reduce its volume. As a next step, the compressed CO₂ is transported for storage or utilization. This can involve trucks or ships for smaller carbon capture projects, or pipeline transport. If the CCS path is elected, the CO₂ is directed to a permanent storage site, such as a subsurface formation, that can retain it indefinitely; suitable storage formations include coal beds, deep saline aquifers or depleted oil or gas fields, and/or can consist of porous rocks like sandstone that absorb the CO₂.

CCS itself is costly however, and in the absence of regulation industries have little incentive to invest in it. CO₂ capture technologies are expensive and large in scale, involving substantial capital outlay to implement. Compressing and transporting the captured CO₂, potentially across long distances, is expensive too, and adds to the complexity of the overall CCS process. As the final stop on the CCS path, the storage facilities themselves must be developed and maintained, involving additional capital expense and operating expense.

Some of these CCS costs can be offset if the CO₂ is used to form other, value-added products instead of simply being impounded in a long-term storage facility, the so-called CCUS approach. However, despite considerable investment in research and pilot-scale projects, industries have developed only a few commercial processes that convert CO₂ into more valuable chemicals. For example, CO₂ can be used in carboxylation reactions where the CO₂ molecule is used to produce chemicals such as methane, methanol, syngas, urea and formic acid, and CO₂ can also be used as a feedstock to produce fuels, e.g., in the Fischer-Tropsch process. In other processes, the chemical industry uses CO₂ to produce high-value products such as salicylic acid, urea, sodium bicarbonate, polycarbonates, and the like. But these pathways for CO₂ utilization currently consume only about 0.3% of the total amount of emitted CO₂, so that they have little effect on overall decarbonization efforts via CCUS.

It would be desirable, therefore, to broaden the commercial opportunities for CO₂ utilization by increasing the number of chemical syntheses that can use CO₂ as a reactant. Pilot scale projects have demonstrated the potential for producing C₁ (CO, CH₄, CH₂OH) molecules and C₂ (oxalic acid) molecules from CO₂. However, commercial-scale synthesis of multicarbon products from CO₂, such as higher olefins, aromatics, and oxygenates (e.g., alcohols, aldehydes, ethers, ketones, and organic acids), has been disappointing, due to difficulties in controlling product selectivity, devising appropriate catalysts, and minimizing catalyst deactivation.

The limited number of processes using CO₂ as feedstock is primarily due to the kinetic and thermodynamic stability of CO₂ itself: it cannot be converted into high-value chemicals or fuels without significant energy input to break its strong bonds. As a consequence, these processes are inefficient, expensive, and impose their own burdens on the environment. These conventional CO₂ conversion processes in commercial use require co-reactants or catalysts, harsh reaction conditions, and large amounts of energy, resulting in significant costs and significant production of waste and greenhouse gases.

As alternatives to traditional thermal CO₂ conversion processes, innovative technologies such as electrochemical, photochemical, solar thermochemical, and biochemical pathways are under investigation, in hopes of avoiding the undesirable consequences of the thermal processes as outlined above. While avoiding some of the costs and environmental burdens associated with conventional CO₂ chemical utilization, none of these methods for using CO₂ as feedstock to produce higher-value chemicals has gained commercial traction, mainly due to the same underlying problem that affects thermal CO₂ conversion processes: the thermodynamically unfavorable energy requirement for breaking the C═O double bonds in CO₂. Non-thermal plasma has been identified as a promising option, recognizing its ability to perform at low temperature and atmospheric pressure, with rapid reaction rates. Non-thermal plasma (NTP) has been used for splitting CO₂ into CO and O₂ and for subsequently reacting CO₂ in mixtures with other hydrogen source gases such as CH₄, H₂, or H₂O. Conventional plasma-based CO₂ conversions systems subject a mixture of CO₂ and the secondary hydrogen source reactant to the high energy conditions of the plasma state in order to activate them both sufficiently to produce the desired products. Various routes have been investigated for such CO₂ conversion reactions using NTP, such as dry reforming of methane (DRM, EQ1), CO₂ hydrogenation (EQ2-EQ4), CO₂ reduction with water (EQ5 and EQ6) and the like:

| | |
|---|---|
| EQ1: CO₂ + CH₄ → 2CO + 2H₂ | ΔH = 247 kJ/mol |
| EQ2: CO₂ + 4H₂ → CH₄ + 2H₂O | ΔH = 165 kJ/mol |
| EQ3: CO₂ + 3H₂ → CH₃OH + H₂O | ΔH = 40.9 kJ/mol |
| EQ4: CO₂ + H₂ → CO + H₂O | ΔH = 41.2 kJ/mol |
| EQ5: CO₂ + H₂O → CO + H₂ + O₂ | ΔH =525 kJ/ mol |
| EQ6: CO₂ + 2H₂O → CH₃OH + 3/2O₂ | ΔH = 676 kJ/mol |

As shown in the preceding equations, CO₂ dissociation is an endothermic process, requiring large amounts of energy to break the C═O double bonds in the molecule. As described previously, thermal dissociation of CO₂ is an energetically inefficient process. Non-thermal plasmas offer advantages over other techniques for CO₂ conversion, because it is energetically more favorable: NTP is known to enable thermodynamically adverse chemical reactions to occur at ambient or near-ambient conditions.

Regardless of the mechanism for initiating and sustaining the NTP however, this technology has not become commercially adopted as a method for CO₂ conversion because of low energy efficiency and low product yield: applying NTP to reactant mixtures comprising CO₂ and other hydrocarbon or organic molecules yields a complex mix of reaction products from which the desired product must be separated. As an example, NTP has been used to convert a feedgas mixture of CO₂ and CH₄ into value-added fuels and chemicals, a process known as dry reforming of methane (DRM), as shown in EQ2 above. However, applying NTP to this feedgas mix has resulted in relatively low yield of the desired products (CO and H₂), and poor selectivity. Unwanted reaction products including C₄ - C₁₀ hydrocarbons and oxygenates (such as methanol, ethanol, 1-propanol, acetic acid and other alcohols, ketones, esters, and carboxylic acids) have been identified, requiring separation from the desired products. Optimizing NTP conditions for this process to obtain higher amounts of the desired products can result in increased soot production, which can interfere with the performance of the catalysts that the process uses. While adding catalysts to the NTP reaction system can improve yield and selectivity, this introduces further complexities due to catalyst chemistry and the interaction of these materials with the plasma itself. Moreover, adding more energy to the system can increase the amount of CO₂ utilized, but also decreases the energy efficiency of the process. NTP processes therefore have not gained commercial traction however, with small yields, poor selectivity, and unfavorable economics. There remains a need in the art, therefore, for processes that use CO₂ as feedstock efficiently to yield commercially valuable amounts of useful chemicals selectively, and in a cost-effective way, requiring minimal amounts of nonrenewable energy, consuming minimal other resources, and producing minimal waste. To achieve these goals, these reactions would advantageously be performed at moderate temperatures and pressures, so that expensive temperature/pressure confinement vessels and intricate and fragile catalysts would not be necessary. In addition, it would be desirable to have those processes for using CO₂ be modular and scalable, so that the facilities for converting CO₂ to useful chemicals would be located near or at the site of CO₂ capture, thus avoiding the costs associated with transporting the CO₂ to a distant storage formation. It would further be desirable that the facility for processing the CO₂ be appropriately sized for the amount of CO₂ capture, so that smaller-scale solutions could be offered for utilizing smaller amounts of CO₂ emissions.

### BRIEF DESCRIPTION OF FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram showing features of a conventional, prior art dielectric barrier discharge system.

FIG. 2 is a block diagram showing features of a CO₂ conversion system as disclosed herein.

FIGS. 3A and 3B are schematic diagrams (cross-sectional and longitudinal projections) of an embodiment of a CO₂ conversion system.

FIG. 4 is a schematic cross-sectional diagram of an embodiment of a CO₂ conversion system.

FIG. 5 is a schematic diagram of an embodiment of a CO₂ conversion system in which a flow of CO₂ is directed into a plurality of high-energy regions.

FIG. 6 is a schematic diagram of an embodiment of a CO₂ conversion system.

### SUMMARY OF THE INVENTION

Disclosed herein, in embodiments, are systems for producing a carbon dioxide conversion product, comprising a carbon dioxide gas source providing carbon dioxide; a delivery system for the carbon dioxide in fluid communication with the carbon dioxide source, wherein the delivery system delivers the carbon dioxide into a plasma reactor, and wherein the plasma reactor energizes the carbon dioxide as a plasma to produce activated carbon dioxide species; a secondary reactant source providing a secondary reactant; a conduit in fluid communication with the secondary reactant source, wherein the conduit directs the secondary reactant to contact the activated carbon dioxide species, wherein contact between the activated carbon dioxide species and the secondary reactant produces the carbon dioxide conversion product, and wherein the carbon dioxide conversion product is entrained in an effluent fluid stream. In embodiments, the plasma reactor comprises a dielectric barrier discharge system. In embodiments, the plasma reactor is formed as a cylinder having an inlet at its proximal end in fluid communication with the delivery system and an outlet at its distal end in fluid communication with the conduit, and wherein the carbon dioxide gas enters the inlet, is converted to the plasma within the plasma reactor, and exits through the outlet as activated carbon dioxide species, and the conduit can be an external cylinder that surrounds the plasma reactor. In embodiments, the secondary reactant comprises hydrogen or is a hydrogen source compound, which can be a liquid, and/or which can be an aliphatic compound; if a liquid, it can be sprayed as an aerosol to contact the activated carbon dioxide species. In embodiments, the secondary reactant is selected from the group consisting of alkanes, alkenes, alkynes, and aromatic compounds. In embodiments, the secondary reactant comprises oxygen or sulfur. In embodiments, the conduit is a planar structure. In embodiments, the activated carbon dioxide species passes through pores in the plasma reactor to contact the secondary reactant. In embodiments, the carbon dioxide conversion product is selected from the group consisting of alcohols, aldehydes, ethers, ketones, and organic acids. In embodiments, the effluent stream is a gaseous stream, and the effluent stream can comprise a gas phase and a liquid phase. In embodiments, the system further comprises a separator in fluid communication with the effluent stream that separates the carbon dioxide conversion product from the effluent stream, and the separator can perform a technique selected from the group consisting of liquefaction, condensation, adsorption, and membrane separation.

Further disclosed, in embodiments, are methods of reacting carbon dioxide and a secondary reactant to form a reaction product, comprising providing a carbon dioxide source, providing a secondary reactant source, and providing a plasma reactor; directing carbon dioxide from the carbon dioxide source to enter the plasma reactor; energizing the carbon dioxide within the plasma reactor to form activated carbon dioxide species; and directing a secondary reactant from the secondary reactant source to interact with the activated carbon dioxide species, thereby forming the reaction product within a product stream. In embodiments, these methods can further comprise separating the reaction product from the product stream. In embodiments, the method can comprise the further step of providing a second plasma reactor, wherein the step of directing the secondary reactant from the secondary source to interact with the activated carbon species includes substeps of first directing the secondary reactant from the secondary reactant source to enter the second plasma reactor and subsequently energizing the secondary reactant within the second plasma reactor to form the activated secondary reactant, following which the activated secondary reactant interacts with the activated carbon species, thereby forming the reaction product within the product stream.

Further disclosed herein, in embodiments, are systems for producing a carbon dioxide conversion product, comprising a carbon dioxide gas source providing carbon dioxide gas; a delivery system for the carbon dioxide gas in fluid communication with the carbon dioxide gas source, wherein the delivery system delivers the carbon dioxide gas into a plasma reactor, and wherein the plasma reactor energizes the carbon dioxide gas as a plasma to produce activated carbon dioxide species; and a secondary reactant source providing a secondary reactant in a secondary reactant stream that is separated from the carbon dioxide gas, wherein the secondary reactant stream is directed to contact the activated carbon dioxide species in a reaction zone, and wherein contact between the activated carbon dioxide species and the secondary reactant in the reaction zone produces a reaction that yields the carbon dioxide conversion product. In embodiments, the plasma reactor forms a non-thermal plasma; the plasma reactor can comprise a dielectric barrier discharge system or a microwave discharge system.

In embodiments, the plasma reactor is formed as a cylinder having a proximal end and a distal end, and having an inlet at the proximal end in fluid communication with the delivery system and an outlet at the distal end in fluid communication with the reaction zone, and wherein the carbon dioxide gas enters the inlet, is converted to the activated carbon dioxide species within the plasma reactor, and exits through the outlet as activated carbon dioxide species to enter the reaction zone. In embodiments, the activated carbon dioxide species can pass through pores in the plasma reactor to enter the reaction zone to contact the secondary reactant therein. In embodiments, the secondary reactant is a hydrogen source compound, which can be hydrogen gas or water. In embodiments, the hydrogen source compound is selected from the group consisting of alkanes, alkenes, alkynes, and aromatic compounds. In embodiments, the secondary reactant comprises a heteroatom, which can be oxygen or sulfur. In embodiments, the secondary reactant selected from the group consisting of alcohols, glycols, ethers, phenols, aldehydes, and ketones.

In certain systems, the secondary reactant is energized separately and delivered to the reaction area in an activated state. In embodiments, the hydrogen source compound is a liquid, which can be dispensed as an aerosol to contact the activated carbon dioxide species in the reaction zone. In embodiments, the secondary reactant stream is directed through a conduit to contact the activated carbon dioxide species in the reaction zone. The conduit can be an external cylinder that surrounds the plasma reactor, or it can be a planar structure. In embodiments, the reaction that produces the carbon dioxide conversion product is selected from the group consisting of substitution reactions, addition reactions, elimination reactions, and rearrangement reactions. In embodiments, the carbon dioxide conversion product is selected from the group consisting of alcohols, aldehydes, ethers, ketones, epoxides, and organic acids.

In embodiments, the carbon dioxide conversion product exits the reaction zone in an effluent fluid stream, which can be a gaseous stream or which can comprise a gas phase and a liquid phase. The system can further comprise a separator in fluid communication with the effluent stream that separates the carbon dioxide conversion product from the effluent fluid stream, and the separator can perform a technique selected from the group consisting of liquefaction, cryogenic condensation, adsorption, and membrane separation to separate the carbon dioxide conversion product from the effluent fluid stream.

Further disclosed herein, in embodiments, are methods of reacting carbon dioxide gas and a differentially activated secondary reactant to form a carbon dioxide conversion product, comprising: providing a carbon dioxide gas source that produces a carbon dioxide gas stream comprising carbon dioxide gas and providing a secondary reactant source that produces a secondary reactant stream comprising a differentially activated secondary reactant, wherein the carbon dioxide gas stream and the secondary reactant stream are separated from each other; providing at least one plasma reactor; directing the carbon dioxide gas stream to enter the at least one plasma reactor while remaining separated from the secondary reactant stream; energizing the carbon dioxide gas within the at least one plasma reactor to form activated carbon dioxide species, wherein the carbon dioxide gas and the activated carbon dioxide species remain separated from the secondary reactant stream; entraining the activated carbon dioxide species in an activated carbon dioxide stream; directing the activated carbon dioxide stream comprising the activated carbon dioxide species to exit the at least one plasma reactor to enter a reaction zone; and directing the secondary reactant stream to enter the reaction zone to interact with the activated carbon dioxide species in the reaction zone, wherein the activated carbon dioxide species reacts with the differentially activated secondary reactant in the reaction zone, thereby forming the carbon dioxide conversion product. In embodiments, the differentially activated secondary reactant is not activated. In other embodiments, the differentially activated secondary reactant is activated in a second plasma reactor prior to the step of directing the secondary reactant stream to interact with the activated carbon dioxide species in the reaction zone. In embodiments, the differentially activated secondary reactant consists essentially of diatomic hydrogen, or comprises oxygen, or consists essentially of diatomic oxygen. In embodiments, the method further comprises a step of removing the carbon dioxide conversion product from the reaction zone in an effluent fluid stream. The effluent fluid stream can be a gaseous stream, or the effluent fluid stream can comprise a gas phase and a liquid phase. In embodiments, the method can further comprise a step of separating the carbon dioxide conversion product from the effluent stream, and the step can employ a separation technique selected from the group consisting of liquefaction, cryogenic condensation, adsorption, and membrane separation. In embodiments, the method further comprises a step of directing the effluent fluid stream away from the reaction zone before the step of separating the carbon dioxide conversion product from the effluent fluid stream.

Also disclosed herein, in embodiments, are methods for producing a carbon dioxide conversion reaction, comprising: providing a primary reactant stream comprising CO₂; providing a secondary reactant stream comprising a hydrogen source reactant intended to react with the CO₂ in the primary reactant stream; separating the primary and the secondary reactant streams and maintaining separation between them; activating the CO₂ in the primary reactant stream in a first plasma to form activated CO₂; shielding the hydrogen source reactant from the first plasma to maintain the hydrogen source reactant in an differentially activated state; and recombining the activated CO₂ with the hydrogen source reactant in the differentially activated state, thereby producing the carbon dioxide conversion reaction. In embodiments, the differentially activated state is an unactivated state.

### DETAILED DESCRIPTION

### 1. Split-Stream Plasma-Based Systems and Methods for CO₂ Conversion

It has been unexpectedly discovered that separating CO₂ (the primary reactant) from any co-reactants (secondary reactants) and treating each reactant stream differentially in a plasma-based CO₂ reaction system can result in their successful combination in a designated reaction zone to accomplish CO₂ conversion. As used herein, the term “CO₂ conversion” refers to any process that causes activated CO₂ to combine chemically with other molecules (secondary reactants) to form more valuable carbon-containing compounds such as alcohols, aldehydes, ethers, ketones, epoxides, and organic acids (oxygenates). Such desired reaction products of CO₂ conversion are considered to be the higher-value chemical products of the reactions. In embodiments, the systems and methods disclosed herein introduce two separate streams into a CO₂ conversion reactor arranged in a split-stream configuration, with the CO₂ stream being directed into a zone of high field-intensity to create and sustain it as a plasma, while the secondary reactant is shielded from the exposure to high-field intensities. In these embodiments, the primary reactant (predominantly CO₂) is excited by the plasma and emerges from the plasma zone to collide with the secondary reactant in the designated reactant region, triggering a cascade of combination/rearrangement reactions that lead to the combination of the secondary reactant with the CO₂ species activated by the plasma to produce CO₂ conversion. The term “CO₂ conversion” can be applied to systems in which activated CO₂ species react with secondary reactants, to distinguish these systems from those in which the CO₂ is simply split into its components with the decomposition of CO₂ into CO and O₂ as described by the following equation (EQ7):

| | |
|---|---|
| EQ7: 2CO₂ → 2CO + O₂ | ΔH =283 kJ/mol |

Non-thermal plasmas can be harnessed advantageously for effecting CO₂ conversion, especially for those reactions using CO₂ as the primary reactant and a hydrogen molecule or hydrogen source molecule as the secondary reactant. As used herein, the term “primary reactant” refers to the reactant (here CO₂) being activated in the plasma-based system to interact with and effect an intended reaction with a separate compound that is used as a substrate for the reaction with the primary reactant. As used herein, the term “secondary reactant” refers to those secondary species that are presented for reaction with the CO₂ that has been activated by the plasma, wherein the reaction of the activated CO₂ with the secondary reactant results in the combination of the CO₂ with the secondary reactant to produce the desired products. As used herein, the term “activated” includes, without limitation, those vibrationally excited, electronically excited, and dissociated species originating from CO₂ due to energy transfer from the plasma; it is recognized that activation can also be performed using other energy sources besides those involved in the formation of plasma, such as thermal energy or other conventional sources. The present invention focuses on activation as takes place in a plasma, preferably a non-thermal plasma (NTP), although such activation can be combined with other types of activation without departing from the principles of these systems and methods.

At its most basic level, a NTP is generated by placing two electrodes in a gas or gas mixture and creating an electrical potential difference between them. The potential difference can be created by direct current, alternating current, or current pulses. Energy to create a NTP can also be provided by other means, such as microwaves or induction coils. The electrons in the NTP attain a high average energy (1 - 10 eV) and reach a high average electron temperature (10,000 - 100,000 K), while the temperature in the gas itself remains low. The high electron energies and temperatures allow the dissociation and/or activation of the gas molecules in the plasma, so that they can rearrange and react to form other products. Since only 5.5 eV is required to break the C═O double bond via the electronic excitation found in plasma, this process is energetically advantageous for CO₂ conversion. Plasma can activate CO₂ molecules by ionization, excitation, and dissociation, creating a cascade of reactive species (excited atoms, ions, radicals, and molecules) to propagate and initiate other chemical reactions.

A number of NTP techniques can be applied to convert CO₂ into other products, offering different electrode geometries, applied pressures, and plasma generation methods. For CO₂ conversion, the major NTP mechanisms are dielectric barrier discharge (DBD) systems, microwave (MW) discharge systems, and gliding arc (GA) discharge systems; other types of NTP for CO₂ conversion can include, without limitation, radiofrequency (RF) discharge, corona discharge, glow discharge, and nanosecond pulse discharge.

Such a system, with separation of the two reactants and with selective plasma energization of only the CO₂ (the primary reactant) or selective plasma energization of the CO₂ and a separate plasma energization of the secondary reactant is referred to herein as a “split-stream” plasma-based system. In either case, whether unactivated, or whether activated differently than and separated from the primary reactant, the secondary reactant can be designated as “differentially activated,” to capture these two possibilities (i.e., activated not at all, or activated differently than but separately from the primary reactant). In the systems and methods disclosed herein, such split-stream systems with an activated primary reactant and a differentially activated secondary reactant can be used effectively for conversion reactions, yielding a variety of valuable products, depending on the choice of a secondary reactant as described herein.

In accordance with these systems and methods, the primary reactant to be energized in the plasma is CO₂. The secondary reactant can be water, hydrogen, or a more complex hydrogen source reactant. As used herein, the terms “hydrogen source reactant” or “hydrogen source molecule” refers to a hydrocarbon or other molecule having one or more hydrogen atoms that can be exchanged with activated CO₂ species in a CO₂ conversion reaction. Examples of hydrogen source molecules include, without limitation, diatomic hydrogen, water, and hydrocarbon compounds such as methane, other light/gaseous hydrocarbons, or other hydrogen sources including aliphatic or aromatic hydrocarbons, including without limitation alkanes or paraffins of various sizes and structures, such as methane (CH4), ethane (C₂H₆, CH₃CH₃), propane (C₃H₈), butane (C₄H₁₀); pentane (C₅H₁₂), hexane (C₆H₁₄), heptane (C₇H₁₆), octane (C₈H₁₈), C₉-C₁₆ alkanes, or heavier molecules, and unsaturated compounds such as alkenes and alkynes, and aromatics.

As mentioned above, CO₂ conversion using NTP has been used to date to energize mixtures of CO₂ and various secondary reactants in an effort to produce higher-value products. The systems and methods disclosed herein, however, are based on the surprising finding that separating the CO₂ from the secondary reactants and activating the CO₂ as the predominant component of a plasma allows the CO₂ to become sufficiently energized that it can then interact with unactivated (non-plasma-treated) or separately activated secondary reactants such as hydrogen or hydrogen source reactants to produce higher-value chemicals. As used herein, the term “predominant component” of a plasma means that CO₂ can be used alone to form the plasma, or it can be combined with other molecules in the plasma as long as the CO₂ is present in sufficient quantities to absorb enough energy in the plasma to become activated. Stated equivalently, for split-stream plasma-based CO₂ conversion, at a minimum CO₂ must be the predominant gas in a mixed feed in a NTP reactor, with the term “predominant” indicating that the CO₂ is present in sufficient quantity that it is energized without “energy theft” from other molecules. As used herein, the term “energy theft” refers to the competitive absorption of energy by a more readily activated reactant in a plasma mixture, with the preferential energization of that reactant in the plasma instead of other co-present reactants; we may term this more readily-activated reactant an “energy thief” as compared to other reactants in the plasma mixture.

If CO₂ is the predominant component of a mixture being energized in a plasma, it has more reactivity in that plasma than any other component(s) of the mixture, and/or it is present in sufficiently large quantities within the plasma that the activated species of the CO₂ are responsible for the intended reactions with the secondary reactant. Thus, even if the CO₂ is combined with other molecules in the plasma, the plasma’s energy is preferentially concentrated on the CO₂ in the mixture instead of activating other components of the mixture. In the split-stream systems and methods disclosed herein, CO₂ is intentionally activated by the plasma, thereby producing activated CO₂, while the secondary reactant is intentionally shielded from that activation. As used herein, the term “activated CO2” or “activated CO₂ species” includes, without limitation, those vibrationally excited, electronically excited, and dissociated species originating from CO₂ due to energy transfer from the plasma.

In embodiments, the secondary reactant can be a hydrogen source reactant, including hydrogen alone, or water; in other embodiments, the secondary reactant can be a heteroatom-containing molecule in which the heteroatom (such as nitrogen, sulfur, phosphorus, or boron) influences the choice of a site for the CO₂ reaction. In embodiments, the use of an amine as a secondary reactant can permit the formation of an amino acid or an amide. If the CO₂ reactant is activated as the predominant component of a plasma, while the hydrogen or other hydrogen source reactant (or other secondary reactant) is deployed as a separate stream to encounter the activated CO₂ without itself being energized in the plasma with the CO₂, this split-stream plasma-based approach avoids the problems of poor yield, low selectivity, and unfavorable energy efficiency encountered in previous plasma-based attempts at CO₂ conversion.

Disclosed herein are systems and methods for CO₂ conversion that are based on this discovery. These systems and methods introduce two separate streams into a CO₂ conversion reactor, with the CO₂ stream being directed into a region of high field-intensity to create and sustain it as a plasma, while a secondary reactant, for example, hydrogen or a hydrogen source reactant (such as, without limitation, methane (CH₄), ethane (C₂H₆, CH₃CH₃), propane (C₃H₈), butane (C₄H₁₀); pentane (C₅H₁₂), hexane (C₆H₁₄), heptane (C₇H₁₆), octane (C₈H₁₈), C₉-C₁₆ alkanes, or heavier molecules or oils (e.g., diesel, gasoline, and the like), unsaturated compounds such as alkenes (e.g., ethylene) and alkynes, and aromatics (e.g., toluene), with or without other functional groups or heteroatoms) is shielded from the exposure to high-field intensities The split-stream plasma-based system therefore allows the co-reaction of CO₂ with an unlimited number of secondary reactants, with insertion of the CO₂-derived polar group into these starting secondary reactants to form oxygenates such as methanol, ethanol, dimethyl ether, formaldehyde, acetaldehyde, and other alcohols, aldehydes, ethers, ketones, epoxides, and organic acids, all with or without heteroatoms. In other embodiments, syngas (CO and H₂) can be formed by combining activated CO₂ species with methane as a secondary reactant, offering an alternative to thermal or plasma-driven DRM processes. Using the split-stream plasma-based system as disclosed herein, the reaction between the activated CO₂ species and the secondary reactant (e.g., the hydrogen or hydrogen source molecule) takes place rapidly, almost immediately, to accomplish CO₂ conversion before the activated CO₂ species have time to dissipate.

The CO₂ conversion products can form within these systems wherever the secondary reactant molecules encounter the activated CO₂ species produced by the plasma, whether within the less energized regions of the plasma reactor itself, or external to the reactor as the activated CO₂ species exit the reactor. The area in which the activated CO₂ encounters the secondary reactant is termed the “reaction zone,” which is identified any area external to the energized portion of the plasma where the primary reactant (CO₂) is being activated. The reaction zone is thus deemed to be peripheral to the plasma acting on the CO₂, with the term “peripheral” encompassing any location that is outside of the energized portion of the plasma where the primary reactant is being activated. The reaction zone thus can be lateral to, external to, distal to, or otherwise outside of the energized portion of the plasma, allowing the CO₂ to be energized separately before it is combined with the secondary reactant. In embodiments, the secondary reactant can also be activated in a separate reactor, with the activated secondary reactant being directed to encounter the activated CO₂ species in a designated reaction zone.

After CO₂ conversion takes place, the resulting products can be entrained in a fluid stream (i.e., liquid or gaseous) of effluents, which can include the desired chemical product(s), other reaction products, and unreacted CO₂ and secondary reactants. The desired chemical product(s), carried within the effluent fluid stream, can be transported away from the reaction zone within the effluent stream, and the effluent stream can undergo further separation using conventional separation techniques to isolate its various components, including the desired chemical product(s).

### 2. CO₂ Conversion Reactions Using Activated CO₂ and Selected Secondary Reactants

In more detail, CO₂ conversion in accordance with the systems and methods disclosed herein is initiated when a feedstock stream containing predominantly CO₂ (the primary reactant) is fed through a plasma which energizes and creates activated CO₂ species. These species are rapidly brought into contact with a secondary reactant that is not exposed to the same plasma. In embodiments, the systems and methods disclosed herein introduce two separate streams into a CO₂ conversion reactor arranged in a split-stream configuration, with the CO₂ stream being directed into a zone of high field-intensity to create and sustain it as a plasma, while a secondary reactant is shielded from the exposure to high-field intensities. In these embodiments, the primary reactant (predominantly CO₂) is excited by the plasma and emerges from the plasma zone to collide with the secondary reactant in the designated reactant region, triggering a cascade of combination/rearrangement reactions that lead to the combination of the secondary reactant with the CO₂ species activated by the plasma to produce CO₂ conversion. The end result is the formation of desired CO₂ conversion products with improved energy efficiency because the plasma energy is focused on CO₂ rather than on the secondary reactants. The reaction products being formed in the reaction zone are also protected from the CO₂ plasma, preventing unwanted back reactions. As a modification, the secondary reactants can also be energized as necessary by a separate plasma. This setup enables tuning the energy inputs into the primary reactant (CO₂) and the secondary reactant(s) to achieve optimal reactivity and energy consumption.

If the desired reaction is a simple one, for example, between CO₂ and hydrogen or between CO₂ and a simple hydrogen source molecule like water, water, the product stream is also relatively simple, containing the desired product and some unreacted reactants. If the reaction is between CO₂ and a more complex hydrogen source molecule, whether a hydrocarbon or a heteroatom-containing molecule, the product stream can include a variety of reaction products derived from the insertion of CO₂ into one or more areas of the hydrogen source molecule, and can further include unreacted CO₂ and unreacted hydrogen source molecules. While it is understood that the activated CO₂ species can be inserted in any location along the hydrogen source molecule to form a mixture of desirable and undesirable products, if the secondary reactant is unenergized there are fewer reactive species interacting, allowing for greater selectivity and higher yield for the desired high-value product(s): since the hydrogen source molecule is not itself energized in the plasma, it has fewer opportunities to form undesired reaction products. In embodiments, the secondary reactant or reactants can also be energized in a separate plasma to form their own activated species, which can then be combined with the activated CO₂ in a designated reaction zone.

Whether the activated CO₂ species react with just hydrogen or react with a more complex hydrogen source molecule, the resultant product stream can be separated into its components using conventional techniques, e.g., liquefaction, pressure swing adsorption, cryogenic condensation, membrane cartridges, absorption/desorption, and the like, so that the desirable reaction product(s) are separated from the other reaction products and the unreacted species. The separated streams can be commercialized separately, and/or recycled back into the system to optimize utilization of the feedstock.

Not to be bound by theory, it is understood that the inert nature of the double bonds in CO₂ renders this molecule relatively resistant to plasma energy if other, more reactive molecules are present: in such a mixture, the other, more reactive molecules are preferentially energized, with insufficient energy being available to break the C═O double bonds predictably and efficiently. In such mixtures, it has been observed that activated CO₂ species exist in exceedingly low concentrations in the plasma when other gases are also present. Instead, in a single plasma containing both CO₂ and H₂O for example, the CO₂ can pass through the plasma reaction zone relatively unactivated, while the plasma energy is absorbed by the H₂O to create ionic or radical species derived from H₂O. In mixtures with CO₂, the more reactive plasma component (such as water, hydrogen, or hydrogen source molecules) acts as an “energy thief,” becoming activated in the plasma while the CO₂ remains unaffected. However, the radicals or ions derived from the secondary reactant have insufficient energy to force the stable CO₂ molecules to convert chemically into desired reaction products.

This discovery explains the unsatisfactory performance of conventional NTP systems that attempt to form higher-value products by energizing mixtures of CO₂ and hydrogen or hydrogen source molecules. Conventional mixtures of CO₂ and hydrogen or hydrogen sources have been used with NTP plasma to perform CO₂ conversion, but as mentioned previously, these processes have yielded poor results. As described above, it has been unexpectedly discovered that the CO₂ molecule is advantageously activated separately by the plasma, using a plasma such as a NTP as an energy source, and using hydrogen or a hydrogen source molecule as an unenergized secondary reactant to form the higher-value products.

The discoveries underlying the split-stream plasma technology as disclosed herein are applicable to all such systems that use plasma technologies to combine separately-activated CO₂ with other secondary reactants to form desirable products: only if the CO₂ molecule is present in the plasma as the sole or predominant component without significant “energy theft” from other molecules can it become sufficiently activated in the plasma to break its double bonds and permit adequate reactivity. Under such advantageous conditions, in the absence of “energy theft” from other molecules, the activated species of CO₂ can then react with other secondary reactant molecules that are brought into contact with these activated species after they have been produced. CO₂′s double bonds can only be sufficiently broken when this molecule is present in the plasma alone or in such quantities that essentially the entire applied energy in the plasma is directed at and absorbed by the CO₂.

In accordance with the principles of the invention, CO₂ entering the plasma is separated from any stream of secondary reactants that might enter the same plasma, even if the CO₂ is admixed with other non-reactive gases. However, this restriction does not mean that CO₂ must be the only component in the feed. In certain embodiments, CO₂ can be advantageously combined in a plasma with an inert gas such as helium, neon, or argon to tune the excitation characteristics of the plasma. These co-components in the plasma can facilitate the breakdown of CO₂ by the NTP, as the energetic (but unreactive) helium, neon, or argon can collide with CO₂. Yet these co-components are not required for effective plasma-driven CO₂ conversion, because the energized CO₂ alone is sufficient to interact with the unenergized hydrogen or hydrogen source molecules to produce higher-value oxygenates (e.g., alcohols, aldehydes, ethers, ketones, epoxides, organic acids), or to interact with other hydrogen source molecules to produce more complex chemicals.

To harness this discovery, systems and methods have been devised as disclosed herein (1) to split the intended reactants into two streams, a primary reactant stream comprising or consisting essentially of the more difficult-to-activate CO₂ molecule, and a secondary reactant stream that comprises the secondary substance(s) intended to react with the primary reactant; (2) to activate the primary reactant stream in a plasma separately from any activation of the secondary reactant; and (3) to recombine the activated primary reactant with the secondary reactant. In embodiments, the main reactant stream can be introduced into the region of high field intensity to create and sustain a plasma, while the secondary reactant stream is shielded from the high field intensity and is directed to interact in an unactivated state with the activated species of the main molecule. In other embodiments, the secondary reactant can be passed through a separate high-field environment to create a plasma that activates the secondary reactant as needed to react with activated CO₂. This decoupling of the activated CO₂ and any activation of secondary reactant(s) increases the tunability of the system to achieve desired selectivities toward the aforementioned products.

In an embodiment, the main reactant molecule is CO₂, and the secondary substance is a hydrogen or a hydrogen source (e.g., a hydrocarbon such as methane, an alkane, an alkene, an alkyne, or an aromatic hydrocarbon, or an oxygen-containing hydrocarbon such as an alcohol, a glycol, an ether, a phenol, aldehyde, a ketone, an epoxide, and the like). The CO₂ then combines with the secondary reactant to yield more complex products such as higher-order hydrocarbons or oxygenates, due to the insertion of the activated CO₂ species into the secondary substance as a substitution reaction, an addition reaction, an elimination reaction, a rearrangement reaction, or the like, or combinations thereof. In embodiments, a wide variety of products can be formed, including without limitation, unsaturated aliphatic hydrocarbons, such as alkynes and alkenes (including olefins such as ethylene and propylene); saturated hydrocarbons (e.g., alkanes, paraffins); cyclic and polycyclic hydrocarbons including aromatic compounds; heterocyclic compounds; and wide spectrum of other oxygen-containing organic compounds such as alkanols (such as monohydric (CₙH₂ₙ₊₁OH), diols or polyols, unsaturated aliphatic, alicyclic, and other alcohols having various hydroxyl attachments); aldehydes such as benzaldehyde, epoxides such as ethylene oxide, nitroalkanes such as nitromethane (CH₃NO₂); carbohydrates, amino acids; and the like, depending on the secondary reactant that is selected.

In certain of systems and methods described herein, a common feature is the use of the CO₂ -only or CO₂-predominant feedstock as the source of the activated species for producing reactions; the non-thermal plasma is imposed only on this feedstock and not on the secondary reactants. Within the reactor system as a whole, a stoichiometrically advantageous reactant ratio is produced by introducing appropriate quantities of the unactivated secondary reactants, for example, the hydrogen-only or hydrogen-rich source stream that can interact with the activated CO₂ species. In addition, desirable molecular recombinations involving the activated species and the secondary reactant are facilitated by introducing the secondary reactant into the reactor system at strategic locations and under strategic conditions.

### 3. Exemplary Reaction Systems and Methods of Their Use

Different types of non-thermal plasma reactors can be used to produce the CO₂ plasma used by these systems and methods; these systems and methods are sufficiently flexible to be used with any desired type of reactor design. Microwave plasmas or radiofrequency plasmas can be used, though such plasmas can require relatively high pressures for optimum utilization, and can be difficult to harness for continuous (as opposed to batch) processing. As an alternative, a dielectric barrier discharge (DBD) system for plasma generation can offer the advantages of continuous operation under atmospheric pressure, with low operating and maintenance costs. To facilitate lower operating temperatures and plasma generation, pressure below atmospheric pressure can be used.

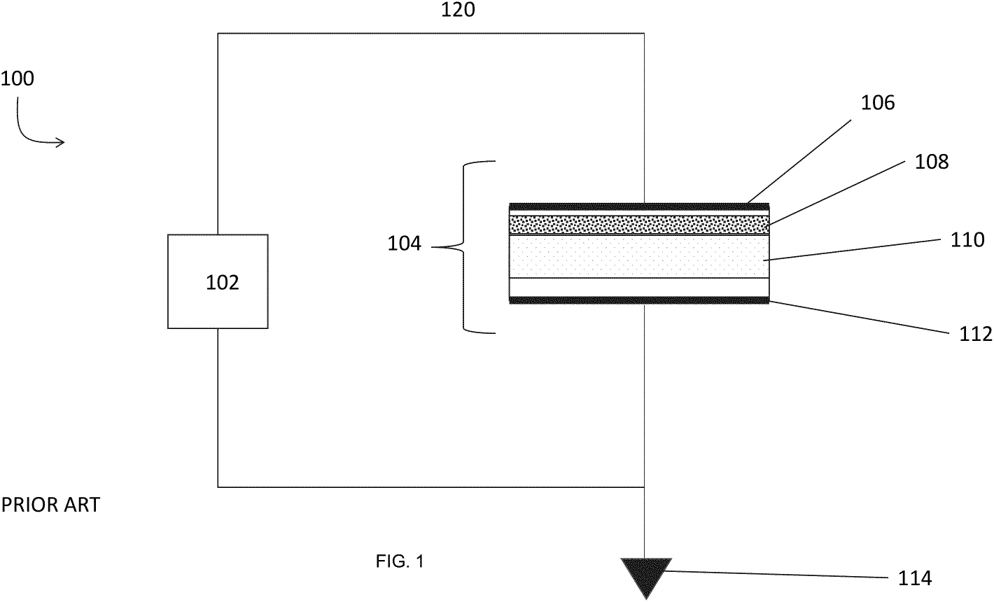

FIG. 1 illustrates schematically the generic components of an exemplary DBD system for plasma generation, as would be familiar to skilled artisans. As shown in FIG. 1, a DBD system 100 includes a power supply 102 and a reactor assembly 104 (shown in cross-section), operatively connected by a circuit 120 and in communication with a ground 114. The power supply provides power to a high voltage electrode 106 (or anode) in the reactor assembly 104, with the ground electrode 112 in the reactor assembly operatively connected to the ground 114. For DBD plasma to be formed, a strong electric field is required. The applied voltage and the distance between the high voltage electrode 106 and the ground electrode 112 determine the strength of the high-energy field that is produced within the reactor region 110; a frequency between 1 KHz and 10 MHz is desirable for generating a DBD plasma. When the electric field is produced, the plasma is generated in the gap between the electrodes. Alternating or direct current can be used in a DBD system.

As shown in this Figure, the high voltage electrode 106 is shielded from the reactor assembly 104 by a dielectric barrier 108, allowing the creation of the high-energy field within the reactor region 110. This high-energy field creates the plasma within the reactor region 110. In embodiments, the reactor region 110 can be formed as a space between the dielectric barrier 108 and the ground electrode 112, for example, if the barrier 108 and the ground electrode 112 are formed as plates, with the high voltage electrode 106 shaped as a plate on top of the dielectric 108. In other embodiments, the reactor region 110 can be formed as a cylinder, with the dielectric barrier 108 surrounding the cylinder, with the high voltage electrode 106 disposed external to the dielectric barrier 108, and with the ground electrode 112 positioned within the cylinder as a coaxial rod. Other arrangements of the components of the reactor assembly 104 will be apparent to artisans of ordinary skill, to permit the generation of the plasma within the reactor region 110 using the DBD system.

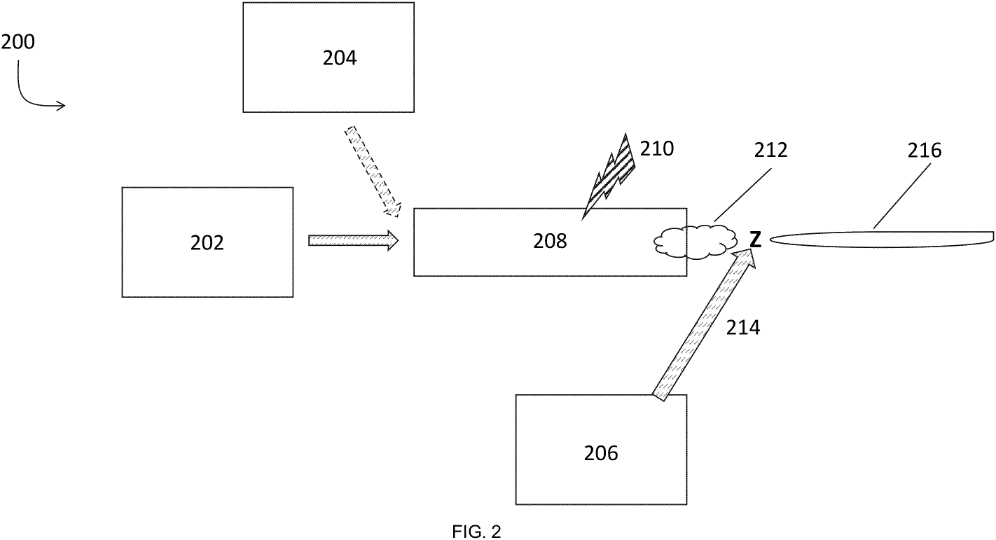

FIG. 2 depicts a block diagram that shows certain features of the systems and methods disclosed herein. FIG. 2 depicts a system 200 for the conversion of CO₂ to higher-value products, comprising a CO₂ source 202 that feeds CO₂ into a plasma reactor 208 energized by an energy source 210. The CO₂ stream can be accompanied by an optional gas stream 204 comprising gases such as inert or noble gases that can act as co-components to facilitate the breakdown of CO₂ within the plasma chamber 208. As the CO₂ encounters the energy in the plasma reactor 208, it is energized to form a plasma, and it exits the plasma reactor 208 as activated CO₂ species 212.

A secondary reactant 214, which can be a hydrogen source compound (including diatomic hydrogen), is delivered from a secondary reactant source 206 to interact with the activated CO₂ species 212. The secondary reactant can be delivered through a conduit (not shown) to a designated reaction zone Z, for example, where the activated CO₂ species 212 emerge from the plasma reactor 208. As used herein, the term “conduit” can refer to any mechanism, structure, chamber, compartment or region through which a secondary reactant is delivered to a designated area or reaction zone Z where it can interact with the activated CO₂ species. The conduit can be a tube, hose, spout, nozzle or the like through which the secondary reactant flows, or it can be a cylinder surrounding or internal to the plasma reactor 208; in other embodiments, where the plasma reactor includes a planar structure such as a plate or where the plasma reactor permits the formation of multiple plasma zones with the interstices of a matrix, the conduit can itself be planar, for example, permitting the deployment of the secondary reactant 214 across a flat or shaped surface so that it comes into contact with the activated CO₂ species as either the secondary reactant or the activated CO₂ species passes through pores, voids or other channels.

The reaction between the activated CO₂ species 212 and the secondary reactant(s) 214 yields a product stream 216 comprising higher-value compounds that result from the CO₂ conversion. While FIG. 2 depicts the collision between the activated CO₂ species 212 and the secondary reactant taking place at the distal end of a plasma reactor 208 as the activated CO₂212 exits the plasma reactor, it is understood that the secondary reactant and the activated CO₂ can be directed towards each other at any convenient location for interaction, i.e., in any reaction zone Z, provided that adequate energy of the activated CO₂ species is retained.

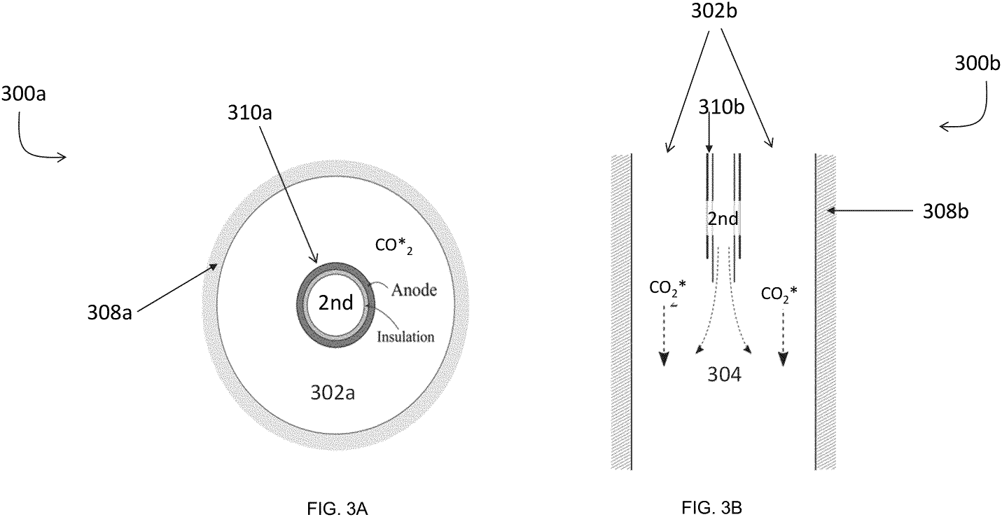

An alternate embodiment is depicted schematically in FIG. 3A and FIG. 3B, where two conduits are coaxially arranged. The inner conduit (310a and 310b) contains a secondary reactant designated in the Figures as “2nd,” which can be hydrogen or hydrogen source molecule, as previously described. The outer conduit (308a and 308b) conveys the primary reactant CO₂ to become activated, designated in the Figures as CO₂*. In the depicted embodiment, the conduit conveying the secondary reactant is maintained within the CO₂-containing structure and is insulated from the plasma-producing energy, while the plasma-producing energy is limited to the structure that confines the CO₂, i.e., the primary reactant conduit 308a and 308b. In the system shown in FIGS. 3A and 3B, the CO₂* stream and the secondary reactant stream (designated as 2nd in the Figure) are kept separate from each other. In these Figures, the conduit 310a and 310b containing the secondary reactant stream 2nd is contained within an outer cylinder 308a and 308b that houses the plasma reaction, while being separated and insulated from the plasma produced in the outer cylinder 308a and 308b.

In the system 300a (shown as a cross-section in FIG. 3A), the anode (“Anode”) for the plasma reactor is disposed on the outer aspect of the secondary reactant conduit 310a, creating the field of high energy intensity 302a within the CO₂-containing cylinder 308a to energize the CO₂ (with activated CO₂ and its dissociation products (the radicals CO* and O*) being collectively represented by CO*₂ in this Figure), but with an insulation layer (“Insulation”) disposed internal to the anode and thereby shielding the secondary reactant from the field of high energy intensity. In the aspect of the system 300b shown in longitudinal section in FIG. 3B, the activated CO₂ and its dissociation products (represented by CO₂* in this Figure) continues to pass through the CO₂-containing structure 308b to encounter the unactivated secondary reactant 2nd as the latter emerges from the distal end of its own conduit. Because the anode ends at the end of the secondary reactant conduit, the plasma formation ceases at that level, and the activated CO₂ (produced by the plasma) and the secondary reactant (insulated from by the plasma) encounter each other in a reaction zone 304 that is not affected by the more proximal area of high plasma energy 302b.

In other embodiments, the activated CO₂ and the secondary reactant can encounter each other through diffusion, whereby the secondary reactant is introduced into a low-energy field that is adjacent to but insulated from the high-energy field where the activated CO₂ is flowing, with the two reactants being separated from each other by a porous barrier that allows passage therethrough. The planar area across which the secondary reactant flows can be termed a “conduit” for this material. In embodiments, the activated CO₂ can pass into the compartment (i.e., the conduit) where the secondary reactant (e.g., hydrogen or hydrogen source compound) is flowing.

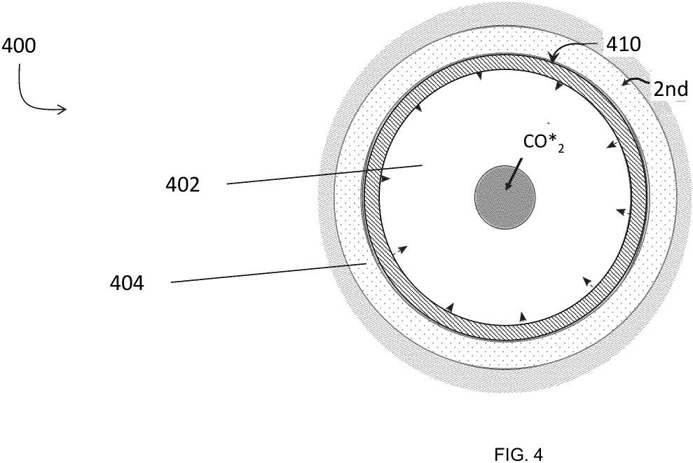

In embodiments, the activated CO₂ species pass into the conduit where the secondary reactant is located; in other embodiments, the secondary reactant passes into the compartment where the activated CO₂ species are being or have been generated. FIG. 4 provides a depiction of such an arrangement. FIG. 4 depicts schematically a cross-section of a system 400 in which the activated CO₂ species and its dissociation products (designated in the Figure as CO₂*) are generated within a central CO₂-containing chamber 402 that contains the high-energy field, while the secondary reactant (designated in the Figure as 2^{nd}) flows through a peripheral conduit 404 that partially or completely envelopes the central plasma chamber 402. An insulating but porous wall or membrane 410 isolates the secondary reactant 2^{nd} from contact with the high energy field and separates the secondary reactant 2^{nd} from the activated CO₂ species; however, the porous nature of the wall or membrane 410 allows the influx of the secondary reactant 2nd (which influx is represented by the plurality of small arrows pointing towards and surrounding the central conduit) to contact the activated CO₂ species outside the plasma zone or at the lower-energy periphery of the plasma zone, where the two reactants commingle and interact to form higher-value CO₂ conversion products.

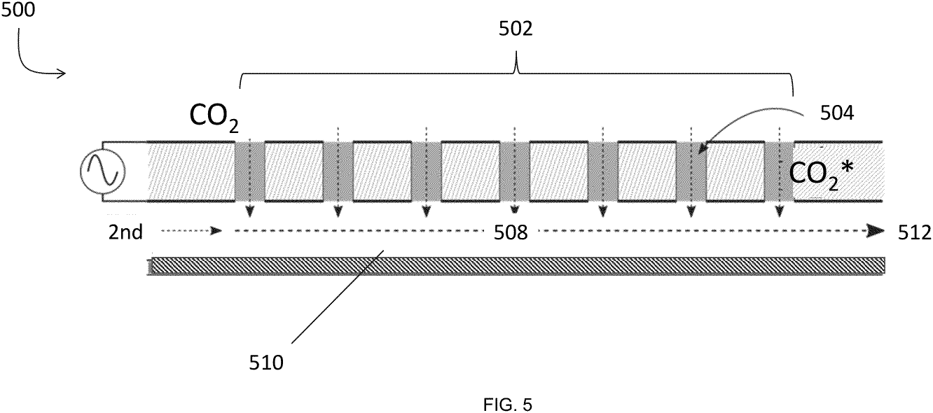

In an alternate embodiment, a series of separate high-energy regions can be created to energize CO₂ gas to form a plasma, for example, in an array or a matrix, with the CO₂ being directed into these high-energy regions to be converted into activated CO₂ species CO₂* and its dissociation products. A representative embodiment is depicted schematically in FIG. 5. As shown in this Figure, a system 500 is shown in cross-section, wherein a flow of CO₂ gas 502 is directed into a plurality of high-energy regions 504 where the CO₂ gas is formed into a plasma, producing the activated CO₂ species CO₂*. The activated CO₂ species CO₂ * emerge from the high-energy regions 504 to encounter a flow 508 of a secondary reactant, e.g., hydrogen gas or a hydrogen source gas (either designated as 2^{nd} in the Figure) within a secondary reaction conduit 510. The interaction of the CO₂* and the 2nd produce the desired product 512, which emerges from the secondary reaction conduit 510 to be separated from any other substances by conventional separation techniques (not shown).

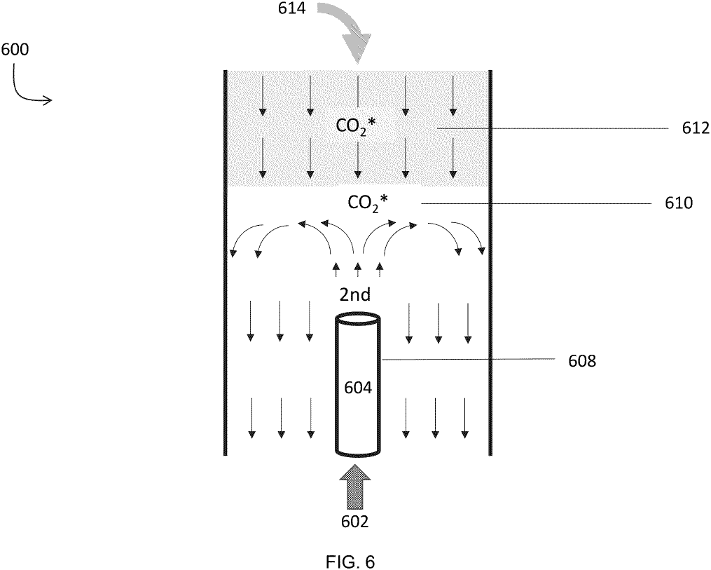

In yet another embodiment, as shown in FIG. 6, a system 600 is shown in cross-section, where a flow of CO₂ source gas 614 is directed into a high-field area in which the CO₂ is formed into a plasma, producing activated CO₂ species CO₂*. In the plasma system 600 depicted in FIG. 6, a feed gas stream 602 comprising one or more secondary reactants in a secondary reactant stream 604 is directed through a secondary reactant injector 608. The stream of secondary reactants 604 for use in the system 600 comprise H₂ and/or a hydrogen source compound such as ethane, ethylene, propane, or the like, or combinations thereof, as has been described above in more detail; such secondary reactants (designated in this Figure as 2nd) enter the reaction zone 610 to encounter the activated CO₂* species being expelled from the high-field region 612. The gas stream comprising the secondary reactant(s) 604 can also include other, non-reactive gases and/or gases that are not considered secondary reactants. Moreover, while a single feed gas stream 602 is shown entering a single secondary reactant injector 608 to direct a single secondary reactant stream 604 into the reaction zone 610, it is understood that a plurality of secondary gas streams can converge and be mixed in a single secondary reactant injector 608 to produce the single secondary reactant stream 604 contained therein. It is further understood that the secondary reactants 2nd in the reaction zone 610 can be provided by a plurality of secondary reactant injectors, each of which delivers one or more secondary reactants 2nd into the reaction zone 610. In the depicted embodiment, the secondary reactant stream 604 is directed from the secondary reactant injector 608 towards a reaction zone 610, where the secondary reactants 2nd interact with plasma-activated CO₂ (which, along with its dissociation products CO* and O* is designated as CO₂ * in this Figure).

As shown in this Figure, the CO₂ * that interacts with the 2nd has been formed from a source gas 614 comprising CO₂, where the CO₂ entrained in the source gas 614 is energized in the high-field region 612 to form the CO₂ *. It is understood that the source gas 614 can comprise other reactive or non-reactive gases, such as, without limitation, helium, neon, argon, and the like. The plasma that energizes the CO₂ to produce CO₂ * in the high-field region can be produced by any of the plasma-producing methods familiar in the art (e.g., produced by microwaves, radiofrequency, DBD, etc.).

The system 600 is designed so that the CO₂ * is directed to encounter the oncoming stream of the secondary reactant 2nd in the reaction zone 610, with the desired product(s) (not shown) being formed in the reaction zone 610 initially by the interaction of the CO₂ * and the 2nd. The reaction zone 610 is situated just outside the high-field region 612 between the outflow tract for the 2nd from the secondary reactant injector 608 and the outflow tract for the CO₂ * from the high field region. This location of the reaction zone 610, outside the high-field region and between the high-field region 612 and the distal end of the secondary reactor 610, allows products (not shown) to be produced that are not themselves affected by the plasma energy in the high-field region 612. Such products as are formed in the reaction zone 610 can be recovered from this location and can be further separated from each other using conventional separation techniques (not shown), allowing desirable products or their precursors to be isolated for further processing.

The position, diameter, and temperature of the secondary reactant injector 608 as well as the flow rates and direction of the CO₂ * and the secondary reactant stream 604 are chosen to achieve a desired flow pattern where the secondary reactant or reactants 2nd do not enter the high-field region 612 but rather encounter the activated CO₂ * in the reaction zone 610. Concomitantly, process parameters are selected so that the activated CO₂ * does not decay before it can react with the secondary reactant(s) 2nd in the reaction zone. Injector designs for the CO₂ and secondary reactant streams can be selected in particular to arrange advantageous flow patterns of the activated CO₂ * and the secondary reactants to optimize their interaction with each other, for example vortices or other specially designed flow patterns. An embodiment of a flow pattern is schematically suggested by the arrows in the Figure, but it is understood that other flow patterns can be designed by artisans of ordinary skill using no more than routine experimentation.

In embodiments, various techniques can be used to separate and capture the higher-value CO₂ conversion products produced by the reactions described herein. In an embodiment, the CO₂ conversion product can be absorbed into a hydrophilic liquid like water, acetone or alcohol, or some other appropriate vehicle for absorption. Since the processes disclosed herein advantageously create familiar commodity product categories such as alcohols, aldehydes, ethers, ketones, and organic acids in the low-energy reaction zones, product separation can be conducted using technologies already known in the art of industrial chemistry. For example, unreacted CO₂, unreacted secondary reactants, and undesirable reaction products can be separated from the intended CO₂ conversion product(s) by standard operations such as PSA (pressure swing adsorption) or membrane cartridges. The separated streams can be recycled back into the system or commercialized separately, as appropriate.

In embodiments, a non-volatile or low-volatility hydrogen-containing substance in liquid form can be directed to contact the CO₂-predominant plasma or can be injected immediately downstream from the CO₂-predomant plasma to act as a secondary reactant. The liquid can be introduced or injected as a liquid stream, or can be presented to the activated CO₂ species distal to the plasma as a pool or a reservoir, or can be atomized into the reaction zone as small droplets, thus increasing the surface area to facilitate contact between the activated CO₂ species and the secondary reactant. With more complex hydrogen-containing substances as secondary reactants, more complex CO₂ conversion products and mixtures thereof are produced by these processes. Conventional separation techniques can be used to separate the various reaction products and remove the unwanted products from the desirable ones, isolating the various products for commercial uses, for disposal, or for recycling, as applicable. Suitable liquid hydrogen source molecules can be selected to produce specific, desirable products; for example, the liquid hydrogen source molecules can be aromatic or aliphatic in nature, of all chain lengths and complexities, used individually or in mixtures. Hydrogen source molecules advantageously can be biologically produced (e.g., both plant-derived and animal-derived agricultural oils) as well as petroleum-derived.

The systems and methods disclosed herein proceed without requiring the use of a catalyst, in contrast to the majority of those plasma-based processes used to effect CO₂ conversion. It has been recognized that conventional plasma systems for CO₂ conversion do not provide sufficient energy to form adequate CO₂-derived reaction products from CO₂ and hydrogen source feedstock mixtures, due to the durability of the C—O double bond; thus, catalysts are required for conventional plasma-assisted CO₂ conversion. Moreover, conventional systems produce mixtures of desirable and undesirable reaction products that need to be separated. Catalysts have been employed in conventional plasma systems both to increase yields and to facilitate separation in conventional plasma systems for CO₂ conversion.

However, by separating the CO₂ from the secondary hydrogen-donating reactant(s) and energizing the CO₂ selectively using the split-stream plasma systems and methods disclosed herein, the plasma energy is concentrated on the CO₂ molecules, yielding activated CO₂ capable of reacting more effectively and efficiently with the hydrogen-donating secondary reactant(s). Thus, using these technologies, catalysts can be avoided. However, despite the advantages to a catalyst-free system, the use of a catalyst can be advantageous under certain circumstances, and catalysts can be optionally employed with the systems and methods disclosed herein. Plasma-assisted CO₂ conversion can thus be carried out using these systems and methods with the inclusion of optional catalysts that are familiar to skilled artisans in the field, in conventional configurations such as powders, wires, whiskers, pellets, and the like.

The embodiments depicted above explicitly embrace using any secondary reactant, whether diatomic hydrogen or a hydrogen source. While hydrogen and hydrogen source reactants such as water and methane are understood to be advantageous secondary reactants for CO₂ conversion reactions performed in accordance with the systems and methods disclosed herein, it is understood that split-stream plasma-based CO2 conversion can be performed using a full spectrum of secondary reactants, as disclosed herein. hydrogen source molecules and oxygen source molecules. As would be appreciated by artisans of ordinary skill, compounds formed by CO₂ conversion reactions using more complex secondary reactants have different chemical properties and behaviors than those formed by using hydrogen, water, or less complex hydrogen source molecules. Appropriate adjustments of the depicted systems can be performed to optimize the CO₂ conversion processes for different secondary reactants, using no more than routine experimentation.

In embodiments, secondary reactants can also include other heteroatoms in molecules that can combine with the activated CO₂ species to form desirable products. For example, a thiol or other organosulfur compound as a secondary reactant can permit the integration of the CO₂ molecule to form more complex sulfur-containing reaction products. As another example, amines or other secondary reactants containing nitrogen can be combined with the activated CO₂ species to form more complex nitrogen-containing reaction products such as amino acids.

### EXAMPLES

The exemplary embodiments are provided below to illustrate more fully the systems and methods disclosed herein.

### Example 1: Coaxial Cylinders With a Dielectric Barrier Discharge (DBD) Reactor

In this Example, two coaxial cylinders can be configured to form a DBD reactor in which the outer electrode is a porous cylinder. This cylinder can form an electrode pair with an inner conductive cylinder, which acts as a counter-electrode. Alternatively, a tightly wrapped wire mesh or the like can be placed next to the exterior surface of the outer cylinder to function as an electrode. An annular interior chamber is positioned between the inner conductive cylinder and the outer cylinder. This coaxial cylinder arrangement is itself enclosed within an outermost chamber.

CO₂ gas can flow into and through the annular interior chamber and is energized by the electrode pair of the electrode and the counter-electrode. Hydrogen or a hydrogen source secondary reactant can be continuously fed into the outermost chamber to flow therethrough. The secondary reactant can also permeate the pores in the outer cylinder to enter the interior chamber, where it encounters the CO₂ plasma and is immediately consumed to yield CO₂ conversion products via a cascade of reactive steps. Since the field intensity next to the inner cylinder is stronger than the intensity nearer to the outer cylinder, CO₂ can be preferentially decomposed, forming the necessary intermediates for the intended CO₂ conversion reactions. The secondary reactant, its breakdown impeded by the low-field intensity in the pores of the ceramic insulator, can emerge from the cylinder wall and rapidly combines with the activated species prevalent in the annular plasma zone.

The field intensity gradient is governed by the radius ratio of the inner and outer cylinders. In addition, the feed rates of CO₂ and the secondary reactant can be individually tuned by modifying variables such as the operating pressure of the plasma zone and its cross-sectional area, the porosity/wall thickness of the outer cylinder, and the hydrogen chamber pressure. The system design is flexible and can permit optimization, product selectivity and process control. Other modifications can be employed to improve efficiencies or to enhance CO₂ breakdown. For example, CO₂ activation and breakdown can be further expedited by bumps or patterned protrusions on the surface of the inner electrode to accentuate the local field intensity. In embodiments, the inner cylinder surface can be ridged or scalloped (parallel or perpendicular to the direction of gas flow) or wrapped with non-conductors such as glass wool.

### Example 2: Coaxial Cylindrical Electrode Pair With Central Hollow Cylinder Electrode

In this Example, non-porous cylinders can be arranged coaxially. The inner cylinder is a hollow tube to allow flow of the secondary reactant, e.g., hydrogen or a hydrogen source gas. While flowing in the inner cylinder, the flow of this gas is unperturbed. The outer aspect of the inner cylinder can act as an electrode. The annular region between the inner cylinder and the outer cylinder can convey CO₂ therethrough, and can be configured as an electrode pair, with the outer cylinder acting as the counter-electrode to the electrode deployed on the outer aspect of the inner cylinder. The imposed electrical field within the annular region can affect the CO₂ to form a plasma. As an alternative to using a DBD arrangement, a microwave-based system or other plasma generation system can be used to form the plasma within the annular region. As the secondary reactant exits the inner cylinder, it can encounter the activated CO₂ species that have been formed in the plasma. In this region, the desired CO₂ conversion products can be formed.

The ends of the inner and outer cylinders can be designed to prevent arcing or field intensification. For example, the inner tube can have a non-conductor section that extends beyond the region defined by the coaxial electrodes. In an embodiment, a hollow metal tube can be tightly fitted with a hollow non-conductor tube inside it to form the inner cylinder assembly. The non-conductor can be longer than the hollow metal tube to extend beyond it. The distance of the extension portion of the non-conductor can be tuned, depending on relative gas flow rates and exact process conditions. Other mechanisms of gas mixing can be introduced in this section to promote collisions of molecules, free radicals, and ions, as desired. As an example, inert packing material (e.g., glass wool) or baffle/agitator designs can be positioned downstream from the distal end of the tube to facilitate mixing the activated species with the secondary reactant.

### Example 3: Parallel Plate Reactor System With Alternating Plasma and Non-Plasma Zones

A system of alternating plasma and non-plasma zones can be arranged in zones using planar geometry. CO₂ gas (or a CO₂-predominant gas mixture) can be directed through a layered activation zone where it encounters plasma and is activated, and a secondary reactant gas can be directed through an adjacent non-energized layer or zone. As the gases emerge from their respective zones, they can combine to produce the desired CO₂ conversion products, for example, alcohols, aldehydes, ethers, ketones, and organic acids. Techniques familiar to skilled artisans can prevent reactor edge arcing and field concentration. This system advantageously allows for expansion simply by stacking additional layers and electrodes. The plasma zones can be sustained by the necessary voltage differential across the two boundary plates, while the non-plasma region can be flanked by plates that remain at the same electrical potential at all times. This design can be tailored for use with AC or DC systems for plasma production; for microwave-generated plasmas, the wave energy can be directed by waveguides to the desired (alternating) channels, for example, using striated waveguides or other designs to direct the wave energy into the desired zones for CO₂ activation.

### Example 4: CO₂ or CO₂-Predominant Plasma Interacting With Hydrogen-Containing Liquid Secondary Reactants

In this Example, plasma can be formed from gas phase CO₂, while hydrogen-containing secondary reactants can be used in a liquid state. The CO₂ plasma can be produced using any of the techniques used for plasma generation, and then the energized CO₂ species can encounter the liquid secondary reactants. This encounter can take place within the plasma chamber or external to it. For example, a liquid secondary reactant can be deployed in a pool or as a layer on a surface exterior to the plasma chamber where it can be struck by the energized CO₂ species. Or, for example, a liquid secondary reactant can be atomized into droplets and sprayed into the plasma chamber to interact with the energized CO₂ species therein, or it can be sprayed external to the plasma chamber to be struck by the energized CO₂ species as they exit the plasma chamber. The increased surface area of the sprayed liquid can bring more of the secondary reactants into contact with the energized CO₂ species, enhancing product formation. Liquids such as petroleum-derived oils or agricultural bio-oils can be used as secondary reactants for this exemplary form of treatment. CO₂ conversion using these secondary reactants can produce polar liquids that can be separated from the secondary reactant feedstock oils for product isolation. In embodiments, atomization techniques can be used to bring the secondary reactant into contact with the energized species derived from the plasma. For example, a polar liquid can be atomized into minute droplets and sprayed so that it encounters the activated species from the plasma. The atomization of the liquid, especially a polar oil, including without limitation oils such as unsubstituted, hydroxy-substituted or carboxy-substituted oils, ketones, aldehydes, ethers, and the like, results in an increased surface area for this secondary reactant that can facilitate interactions with the active species.

### Example 5: Microwave CO₂ Plasma Impinging On a Flow of Propane

A setup similar to the design in FIG. 6 was used to react a CO₂ plasma with propane. CO₂ was injected in a vortical manner at a flow rate of 3.5 SLPM from a stainless-steel nozzle. Propane was injected in a vortical manner at a flow rate of 1.5 SLPM from a separate stainless steel nozzle. The plasma reactor was a fused quartz vessel with an inner diameter of 46 mm and an outer diameter of 50 mm. A 400 W 2.45 GHz microwave source was focused to create the CO₂ plasma. The CO₂ injector was located 12.5 - 14 in. above the plasma center, and the propane injector was located 2 - 3.5 in. below the plasma center. The pressure at the outlet of the reactor chamber was measured to be between -12.44 and -12.76 psig. Typical utilization of CO₂ ranged from 23 - 27% of the amount supplied, and propane utilization ranged from 24 -27% of the amount supplied. The qualitative product distribution was as follows: CO/O₂ > ethylene > acetylene ~ propylene > propyne.

While this invention has been particularly shown and described with references to preferred embodiments thereof, it will be understood by those skilled in the art that various changes in form and details may be made therein without departing from the scope of the invention encompassed by the appended claims.

1. A system for producing a carbon dioxide conversion product, comprising:
a carbon dioxide gas source providing carbon dioxide gas;
a delivery system for the carbon dioxide gas in fluid communication with the carbon dioxide gas source, wherein the delivery system delivers the carbon dioxide gas into a plasma reactor, and wherein the plasma reactor energizes the carbon dioxide as a plasma to produce activated carbon dioxide species; and
a secondary reactant source providing a secondary reactant in a secondary reactant stream that is separated from the carbon dioxide gas, wherein the secondary reactant stream is directed to contact the activated carbon dioxide species in a reaction zone, and wherein the contact between the activated carbon dioxide species and the secondary reactant in the reaction zone produces a reaction that yields the carbon dioxide conversion product.

2. The system of claim 1, wherein the plasma reactor forms a non-thermal plasma.

3. The system of claim 2, wherein the plasma reactor comprises a dielectric barrier discharge system or a microwave discharge system.

4. The system of claim 1, wherein the plasma reactor is formed as a cylinder having a proximal end and a distal end, and having an inlet at the proximal end in fluid communication with the delivery system and an outlet at the distal end in fluid communication with the reaction zone, and wherein the carbon dioxide gas enters the inlet, is converted to the activated carbon dioxide species within the plasma reactor, and exits through the outlet as activated carbon dioxide species to enter the reaction zone.

5. The system of claim 1, wherein the activated carbon dioxide species passes through pores in the plasma reactor to enter the reaction zone to contact the secondary reactant therein.

6. The system of claim 1, wherein the secondary reactant is a hydrogen source compound.

7. The system of claim 6, wherein the hydrogen source compound is hydrogen gas.

8. The system of claim 6, wherein the hydrogen source compound is H₂O.

9. The system of claim 6, wherein the hydrogen source compound is selected from the group consisting of alkanes, alkenes, alkynes, and aromatic compounds.

10. The system of claim 1, wherein the secondary reactant comprises a heteroatom.

11. The system of claim 10, wherein the heteroatom is oxygen or sulfur.

12. The system of claim 11, wherein the secondary reactant is selected from the group consisting of alcohols, glycols, ethers, phenols, aldehydes, and ketones.

13. The system of claim 1, wherein the secondary reactant is energized separately and delivered to the reaction area in an activated state.

14. The system of claim 6, wherein the hydrogen source compound is a liquid.

15. The system of claim 14, wherein the liquid is dispensed as an aerosol to contact the activated carbon dioxide species in the reaction zone.

16. The system of claim 1, wherein the secondary reactant stream is directed through a conduit to contact the activated carbon dioxide species in the reaction zone.

17. The system of claim 16, wherein the conduit is an external cylinder that surrounds the plasma reactor.

18. The system of claim 16, wherein the conduit is a planar structure.

19. The system of claim 1, wherein the reaction that produces the carbon dioxide conversion product is selected from the group consisting of substitution reactions, addition reactions, elimination reactions, and rearrangement reactions.

20. The system of claim 1, wherein the carbon dioxide conversion product is selected from the group consisting of alcohols, aldehydes, ethers, ketones, epoxides, and organic acids.

21. The system of claim 1, wherein the carbon dioxide conversion product exits the reaction zone in an effluent fluid stream.

22. The system of claim 21, wherein the effluent fluid stream is a gaseous stream.

23. The system of claim 21, wherein the effluent fluid stream comprises a gas phase and a liquid phase.

24. The system of claim 21, further comprising a separator in fluid communication with the effluent stream that separates the carbon dioxide conversion product from the effluent fluid stream.

25. The system of claim 24, wherein the separator performs a technique selected from the group consisting of liquefaction, cryogenic condensation, adsorption, and membrane separation to separate the carbon dioxide conversion product from the effluent fluid stream.

26. A method of reacting carbon dioxide gas and a differentially activated secondary reactant to form a carbon dioxide conversion product, comprising:
providing a carbon dioxide source that produces a carbon dioxide gas stream comprising carbon dioxide gas, and providing a secondary reactant source that produces a secondary reactant stream comprising a differentially activated secondary reactant, wherein the carbon dioxide gas stream and the secondary reactant stream are separated from each other;
providing at least one plasma reactor;
directing the carbon dioxide gas stream to enter the at least one plasma reactor while remaining separated from the secondary reactant stream;
energizing the carbon dioxide gas within the at least one plasma reactor to form activated carbon dioxide species, wherein the carbon dioxide gas and the activated carbon dioxide species remain separated from the secondary reactant stream;
entraining the activated carbon dioxide species in an activated carbon dioxide stream;
directing the activated carbon dioxide stream comprising the activated carbon dioxide species to exit the at least one plasma reactor to enter a reaction zone; and
directing the secondary reactant stream to enter the reaction zone to interact with the activated carbon dioxide stream in the reaction zone, wherein the activated carbon dioxide species reacts with the differentially activated secondary reactant in the reaction zone, thereby forming the carbon dioxide conversion product.

27. The method of claim 26, wherein the differentially activated secondary reactant is not activated.

28. The method of claim 26, wherein the differentially activated secondary reactant is activated in a second plasma reactor prior to the step of directing the secondary reactant stream to interact with the activated carbon dioxide in the reaction zone.

29. The method of claim 26, further comprising a step of removing the carbon dioxide conversion product from the reaction zone in an effluent fluid stream.

30. The method of claim 29, wherein the effluent fluid stream is a gaseous stream.

31. The method of claim 29, wherein the effluent fluid stream comprises a gas phase and a liquid phase.

32. The method of claim 29, further comprising a step of separating the carbon dioxide conversion product from the effluent fluid stream.

33. The method of claim 32, wherein the step of separating employs a separation technique selected from the group consisting of liquefaction, cryogenic condensation, adsorption, and membrane separation.

34. The method of claim 33, further comprising a step of directing the effluent fluid stream away from the reaction zone before the step of separating the carbon dioxide conversion product from the effluent fluid stream.

35. A method for producing a carbon dioxide conversion reaction, comprising:
providing a primary reactant stream comprising CO₂;
providing a secondary reactant stream comprising a hydrogen source reactant intended to react with the CO₂ in the primary reactant stream;
separating the primary and the secondary reactant streams and maintaining separation between them;
activating the CO₂ in a first plasma to form activated CO₂;
shielding the hydrogen source reactant from the plasma to maintain the hydrogen source reactant in a differentially activated state; and
recombining the activated CO₂ with the hydrogen source reactant in the differentially activated state.

36. The method of claim 35, wherein the differentially activated state is an unactivated state.
